(19) United States
(12) Patent Application Publication
(10) Pub. No.: US 2011/0272976 A1
(43) Pub. Date: Nov. 10, 2011

(54) TATTOO CHAIR

(76) Inventors: Wen Wei, Los Angeles, CA (US); Michael Chen, Los Angeles, CA (US); Billy Chen, Los Angeles, CA (US)

(21) Appl. No.: 12/739,882

(22) PCT Filed: Sep. 22, 2008
(86) PCT No.: PCT/CN08/01636

§ 371 Date: Jul. 25, 2011

(30) Foreign Application Priority Data
Oct. 31, 2007 (CN) 200720195884.6

(51) Int. Cl. A61G 15/02; A47C 3/00; A47C 7/50; A47C 1/06; A47C 1/10; A61G 15/12; A47C 1/00

(52) U.S. Cl. 297/195.11; 297/354.1; 297/344.12

(57) ABSTRACT

A tattoo chair, comprises a backrest (1), a seat (2), a brace (3) for supporting the said seat (2), and a base (4) for allowing the chair to stand stably, the lower end of the said backrest (1) is rotatablely attached to the inner side of the said seat (2); a supporting fixed plate (5) is provided under the bottom surface of the said seat (2); at least one fixed gear rack (10) is mounted from top to bottom on the rear surface of the said backrest (1); a supporting rod (50) is provided on the said supporting fixed plate (5); one end of the said supporting rod (50) is rotatablely attached to the said supporting fixed plate (5), and the other end is put into one of grooves of the said gear rack (10) on the rear surface of the said backrest (1).

### TECHNICAL FIELD

The present invention generally relates to the field of chairs, and more particularly, the invention relates to a tattoo chair.

### BACKGROUND

A tattoo chair is for a person who is getting tattoos to sit on. The existing tattoo chairs often comprise of a backrest, a seat, armrests, a brace and a base. Neighboring sides of the backrest and the seat are fixedly and vertically connected so that the seated person may lean against the backrest. The armrests are fixed on both sides of the seat for supporting the arms and improving the comfort. The brace is set between the seat and the base, and the seat stably stands on the ground through the brace. The obvious drawback with such known solutions is that height of the brace is not adjustable, which brings inconveniences in use. Consequently, chairs with height adjustable braces for providing different heights have already been available on the market.

The existing height adjustable tattoo chairs allow a person getting tattoos to sit right toward his front. That's to say, it's convenient to tattoo the shoulder of the person, but quite inconvenient to tattoo other regularly tattooed parts of the body, such as back, belly, waist and leg, etc. Furthermore, both tattoo artist and the person getting tattoos feel tired when tattooing in such an inconvenient situation. Therefore, there is a need to provide a tattoo chair making it convenient to tattoo regular tattooed parts of body, and making the person getting tattoos feel comfortable while being tattooed.

### SUMMARY

According to one aspect, a tattoo chair is provided facilitating the person getting tattoos to adopt different poses, so that the tattoo artist can work more easily; furthermore, when getting tattoos in various poses, the person will feel free and at ease without any discomfort.

According to another aspect, a tattoo chair comprises a backrest, a seat, a brace for supporting the seat, and a base for allowing the chair to stand stably, wherein the lower end of the backrest is rotatablely attached to the inner side of the seat; a supporting fixed plate is provided under the bottom surface of the seat to avoid direct interaction between the brace and seat and improve wear-resistance of the seat; at least one fixed gear rack is mounted from top to bottom on the rear surface of the backrest; a supporting rod is provided on the supporting fixed plate; one end of the supporting rod is rotatablely attached to the supporting fixed plate, the other end is put into the groove of the gear rack on rear surface of the backrest; when the supporting rod is taken out of the groove of the fixed gear rack, the whole backrest can rotate around the seat; by positioning the supporting rod into different grooves of the fixed gear rack, inclination of the backrest can be adjusted; as the supporting rod is completely released, the backrest can rotate to be flush with the seat.

Further, in order to prevent the supporting rod from unexpectedly falling out of the groove of the fixed gear rack, a spring can be provided between the lower part of inner side of the seat and the supporting rod.

Further, the brace can be a hydraulic lifting device with its height adjusted via a pedal; the supporting fixed plate can rotate 360 degrees around the axis of the hydraulic lifting device. This configuration facilitates the person getting tattoos to bestride the tattoo chair, and it is convenient to tattoo the upper part of the person's back by lowering the height of the brace and tattoo the waist by raising the height of the brace.

As a further improvement, the armrests can be provided on left, right, or both sides of the seat and the backrest. Snap spring holes can be provided in the seat and the backrest; fixing axes are provided on sides of both ends of the armrests to match the snap spring holes. Grooves for positioning can be provided on the fixing axes to match the snap springs in the snap spring holes; thus, the fixing axes can be inserted into or taken out of the snap spring holes; this structure makes the person with his/her arms getting tattoos feel more comfortable.

As a further improvement, a headrest can be provided on top of the backrest; a fixing axis with grooves can be provided at bottom of the headrest; a snap spring hole can be provided on the upper surface of the backrest to match the fixing axis such that the headrest can be either mounted on or taken away from the backrest, and the headrest is more applicable for a tall person getting tattoos.

As a further improvement, an arc hole can be provided in the center of the headrest for the person getting tattoos to locate his/her face in it when he/she faces right toward the headrest.

As a further improvement, a cushion can be provided on the surface of the headrest, and the cushion can be connected with the headrest through a velcro tape so that the cushion can be mounted and detached easily; the cushion makes the person getting tattoos feel more comfortable when leaning his/her head against the cushion.

As a further improvement, a leg rest can be provided in the front of the seat, and the leg rest is rotatablely attached to the seat. Leg rest supporting rods can be provided on the rear surface of the leg rest, and a leg rest fixing brace can be provided on the supporting fixed plate under the seat. The leg rest supporting rods are movably connected with the leg rest fixing brace. By adjusting the position of the leg rest supporting rods on the leg rest fixing brace, the inclination of the leg rest can be changed. The leg rest may be adjusted from horizontal position to vertical position. This configuration makes it quite convenient to tattoo the leg of the person getting tattoos.

As a further improvement, the leg rest can be a symmetrically separate structure comprising a left leg rest and a right leg rest each having a leg rest supporting rod; a left and a right leg rest fixing braces are mounted on the supporting fixed plate to match the left and the right leg rest supporting rods respectively. The separate structure allows adjusting the left and right leg rests respectively. This configuration allows for adjusting the position of each leg of the person getting tattoos when he/she is sitting right toward the front or lying on one's back, if needed.

As a further improvement, a position-matched leg rest extension can be provided on the lower end of the leg rest, where a snap spring holes are provided. Fixing axes with grooves can be provided on the side of the leg rest extension connected to the leg rest. The fixing axes can be inserted into the snap spring holes in the lower end of the leg rest so as to connect the leg rest extension to the leg rest. The fixing axes on the leg rest extension can also be pulled out of the snap spring holes to take the leg rest extension away from the leg rest. This extension structure is more applicable for a tall person having long legs to get tattoos.

Advantageously, a tattoo chair according to the present disclosure allows the person getting tattoos to adopt different poses so that the tattoo artist can work more easily. Further, when getting tattoos, the person will feel free and at ease without any discomfort in various poses.

### BRIEF DESCRIPTION OF THE DRAWINGS

The subject disclosure may be best understood with reference to the following detailed description, taken in connection with the accompanying drawings, in which:

FIG. 1 is a side perspective view of a tattoo chair according to a specific embodiment of the present disclosure;

FIG. 2 is a side view of the tattoo chair according to another specific embodiment of the present disclosure;

FIG. 3 is a front view of an armrest of the present disclosure for the tattoo chair;

FIG. 4 is a side perspective view of a tattoo chair according to still another specific embodiment of the present disclosure;

FIG. 5 is a perspective view of a headrest of the present disclosure for the tattoo chair;

FIG. 6 is a perspective view of a tattoo chair according to yet another specific embodiment of the present disclosure;

FIG. 7 is a perspective view of the tattoo chair of FIG. 6 shown in a state of use according to a specific embodiment of the present disclosure; and

FIG. 8 is a side elevation view of a tattoo chair according to a specific embodiment of the present disclosure.

### DETAILED DESCRIPTION OF EMBODIMENTS

### Embodiment 1

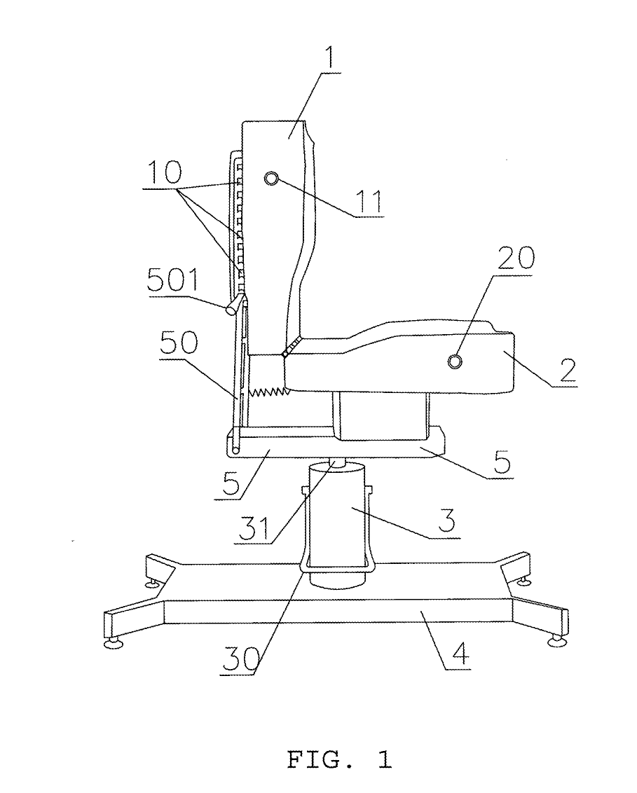

Referring to FIGS. 1, 2, 4, 6, 7 and 8, a tattoo chair comprises the backrest 1, seat 2, brace 3 for supporting the seat 2, and base 4 for allowing the chair to stand stably.

The inner side of the lower end of the backrest 1 is rotatablely attached to the inner side of the seat 2 through a hinge. The seat 2 is fixed, and the backrest 1 can rotate around the inner side of the seat 2. The backrest 1 can rotate counterclockwise relative to the seat 2 ninety degrees at most, that is, the backrest 1 can its lowest be flush with the seat 2. A supporting fixed plate 5 is provided under the bottom surface of the seat 2 to avoid direct contact between the brace 3 and seat 2 and improve the wear-resistance of the seat 2. A fixed gear rack 10 is mounted from top to bottom on the rear surface of the backrest 1, and one or more the racks may be mounted in a longitudinal direction; a supporting rod 50, for example in a Π-shape, is attached to the supporting fixed plate 5; the left and right lower ends of the supporting rod 50 are rotatablely attached to the supporting fixed plate 5, while the upper cross rod 501 is put into the groove of the gear rack 10 on the rear surface of the backrest 1. When the cross rod 501 of the supporting rod 50 is taken out of the groove of the fixed gear rack 10, the whole backrest 1 can rotate around the seat 2. By positioning the cross rod 501 of the supporting rod 50 on the fixed gear rack 10, the inclination of backrest 1 can be adjusted. As the supporting rod 50 is completely released, the backrest 1 can rotate to be flush with the seat 2.

Referring to FIGS. 1, 2, 4 and 8, further, in order to prevent the supporting rod 50 from unexpectedly falling out of the groove of the fixed gear rack 10, a spring 502 is provided between the lower part of inner side of the seat 2 and middle part of the supporting rod 50.

Referring to FIGS. 1, 2, 4, 6, 7 and 8, further, the brace 3 is a hydraulic lifting device with its height adjusted via a pedal 30. The supporting fixed plate 5 can rotate 360 degrees around the axis 31 of the hydraulic lifting device 3. This configuration facilitates the person getting tattoos to bestride the tattoo chair. The upper part of a person's back can be tattooed conveniently by lowering the height of the brace 3, and the waist of a person can be tattooed conveniently by raising the height of the brace 3.

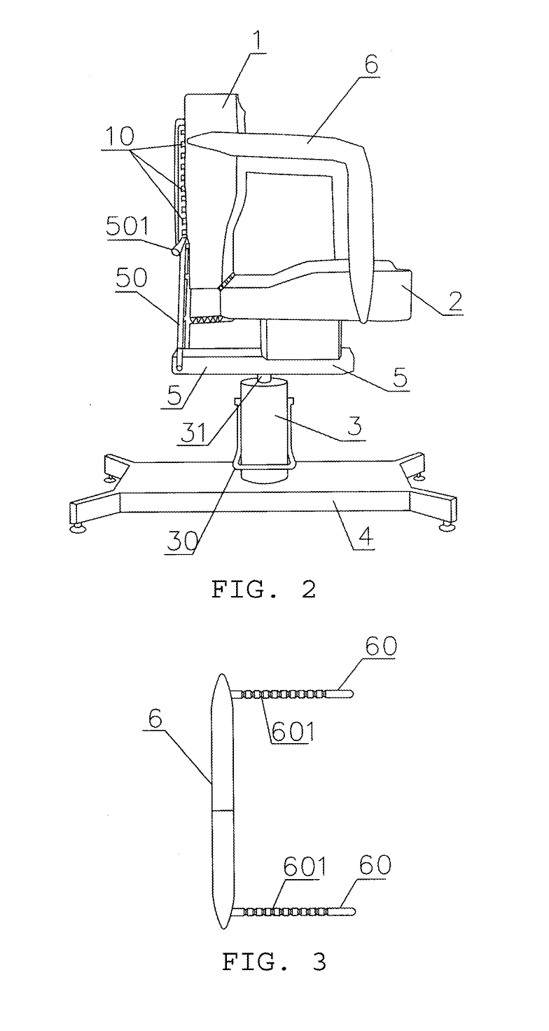

Referring to FIGS. 2, 3, 4, 6, 7 and 8, in accordance with the further improved embodiment, armrests 6 are provided on the left, right, or both sides of the seat 2 and backrest 1. Snap spring holes 20, 11 are provided in the seat 2 and backrest 1. Fixing axes 60 are provided on the side of both ends of the armrests 6 to match the snap spring holes 20, 11, and grooves 601 for positioning are provided on the fixing axes 60 to match the snap springs in the snap spring holes 20, 11 so that the fixing axes 60 can be inserted into or taken out of the snap spring holes 20, 11. This configuration makes the person getting tattoos on his/her arms feel more comfortable.

Referring to FIGS. 4, 5, 6, 7 and 8, in accordance with the further improved embodiment, an easily mounted and detached headrest 7 is provided on the top of the backrest 1. A fixing axis 70 with grooves 701 is provided at the bottom of the headrest 7. A snap spring hole (not shown) is provided on the upper surface of the backrest 1 to match the fixing axis 70. Thus, the headrest 7 can be either mounted onto or taken away from the backrest 1. The headrest 7 is more applicable for a tall person getting tattoos.

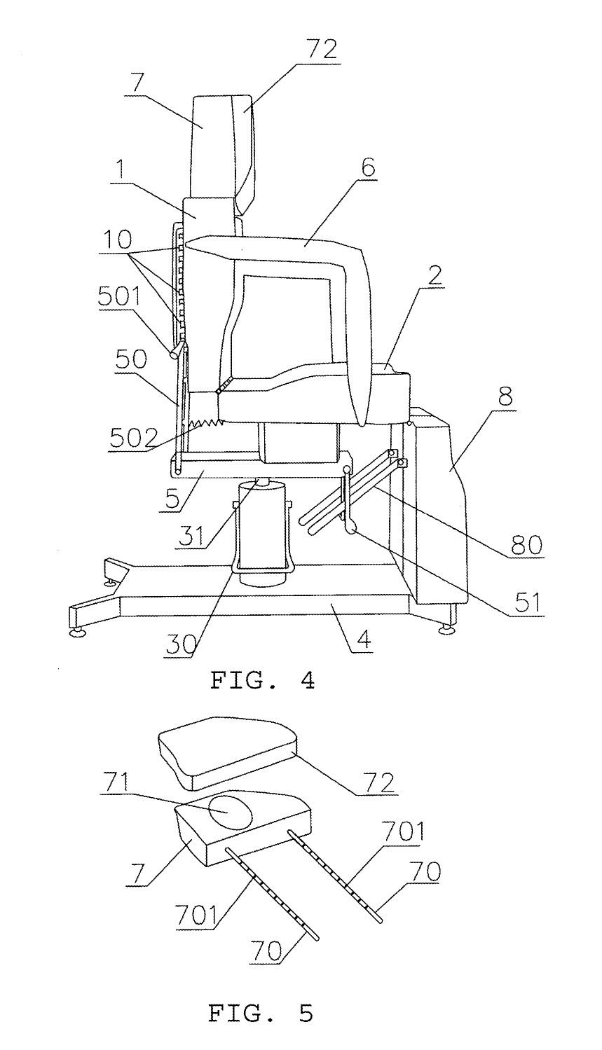

Referring to FIG. 5, in accordance with the further improved embodiment, an arc hole 71, preferably having a shape matching a face, is provided in the center of the headrest 7 for the person getting tattoos to locate his/her face when bestriding the tattoo chair.

Referring to FIGS. 4, 5, 6, 7 and 8, in accordance with the further improved embodiment, a cushion 72 is provided on the surface of the headrest 7, and the cushion 72 is connected with the headrest 7 through a velcro tape so that the cushion can be mounted and detached easily. The cushion 72 makes the person getting tattoos feel more comfortable when his/her head leans against the cushion.

Referring to FIGS. 4, 6, 7 and 8, in accordance with the further improved embodiment, a leg rest 8 is provided in the front of the seat 2. The leg rest 8 is rotatablely attached to the seat 2 through hinges. While the seat 2 is fixed, the leg rest 8 can rotate around the seat 2 clockwise from horizontal position. Leg rest supporting rods 80 are provided on the rear surface of the leg rest 8. A leg rest fixing brace 51 is mounted on the supporting fixed plate 5 under the seat 2. The leg rest supporting rods 80 are movably connected with the leg rest fixing brace 51. By adjusting the position of the leg rest supporting rods 80 with regard to the leg rest fixing brace 51, the inclination of the leg rest 8 with regard to the horizontal plane can be adjusted. The leg rest 8 can rotate around the seat 2 from horizontal position to vertical position. This configuration makes it quite convenient to tattoo the leg of the person.

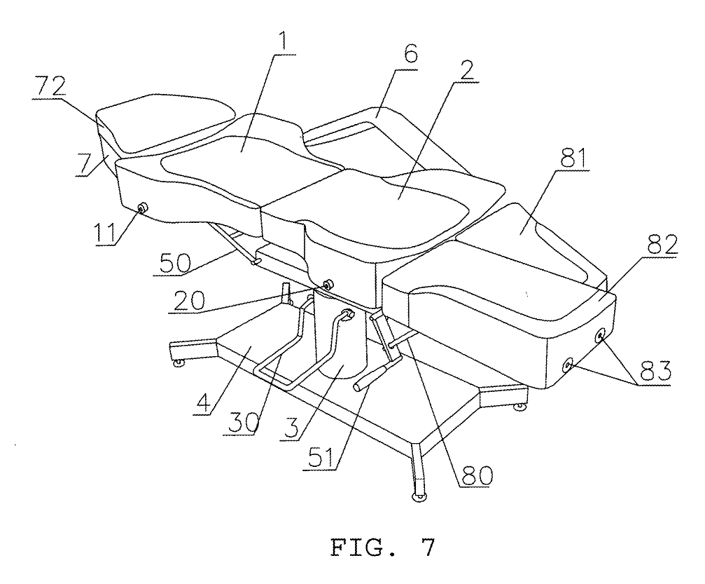

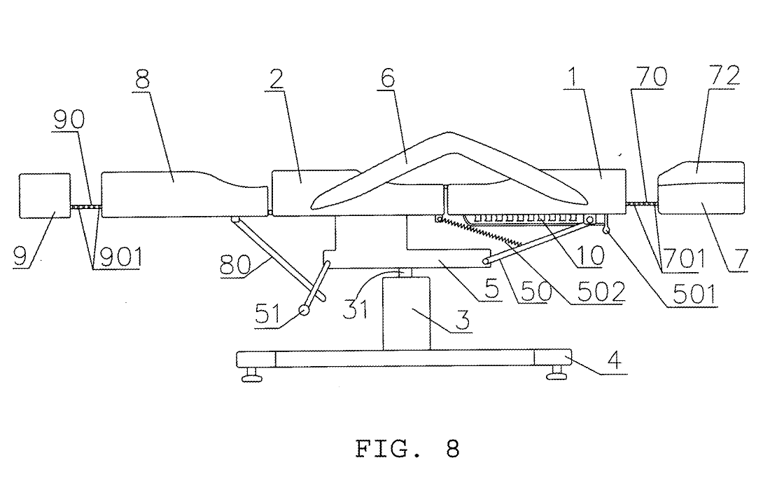

Referring to FIG. 7, in accordance with the further improved embodiment, the leg rest 8 is a symmetrically separate structure comprising a left leg rest 81 and a right leg rest 82, each having a leg rest supporting rod 80. The left and the right leg rest fixing braces 51 are mounted on the supporting fixed plate 5 to match the supporting rods 80 of the left and right leg rests 81, 82, respectively. The separate structure allows adjusting the left and the right leg rests 81, 82 respectively. This configuration allows for adjusting the position of each leg of the person getting tattoos, if needed, when he/she is sitting or lying on his/her back.

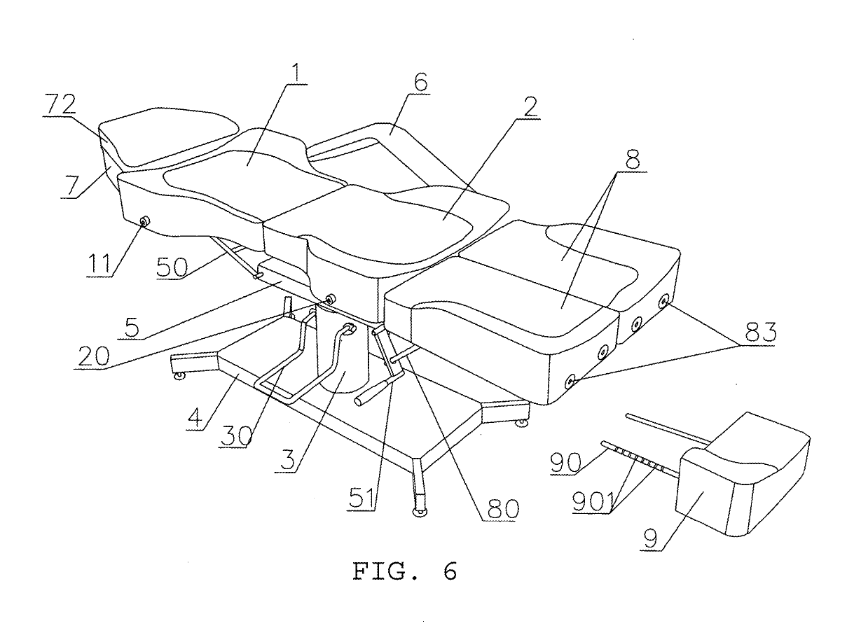

Referring to FIGS. 6 and 8, in accordance with the further improved embodiment, a position-matched leg rest extension 9 is provided on the lower end of the leg rest 8, where snap spring holes 83 are provided. Fixing axes 90 with grooves 901 are provided on the side of the leg rest extension 9 connected to the leg rest 8. The fixing axes 90 can be inserted into the snap spring holes 83 in the lower end of the leg rest 8 to connect the leg rest extension 9 to the leg rest 8. The fixing axes 90 on the leg rest extension 9 can also be pulled out of the snap spring holes 83 to take the leg rest extension 9 away from the leg rest 8. This extension structure is more applicable for a tall person having long legs to get tattoos.

Obviously, the embodiments described above are provided for purpose of clear explanation but not for limiting the present disclosure. In fact, it will be appreciated to those skilled in the art that various modifications and variations may be made in the present disclosure without departing from the spirit or scope thereof. Accordingly, any apparent alteration or modification derived from the subject disclosure will be in the scope of protection of the present disclosure.

1. A tattoo chair, comprises a backrest, a seat, a brace for supporting the said seat, and a base for allowing the chair to stand stably, wherein the lower end of the said backrest is rotatablely attached to the inner side of the said seat; a supporting fixed plate is provided under the bottom surface of the said seat; at least one fixed gear rack is mounted from top to bottom on the rear surface of the said backrest; a supporting rod is provided on the said supporting fixed plate; one end of the said supporting rod is rotatablely attached to the said supporting fixed plate, and the other end is put into one of grooves of the said gear rack on the rear surface of the said backrest.

2. A tattoo chair of claim 1, wherein a spring is provided between the lower part of inner side of the said seat and the supporting rod.

3. A tattoo chair of claim 1, wherein the said brace is a hydraulic lifting device with its height adjusted via a pedal, and the said supporting fixed plate can rotate 360 degrees around the axis of the hydraulic lifting device.

4. A tattoo chair of claim 1, wherein armrests are provided on the left, right, or both sides of the said seat and backrest; snap spring holes are provided in the said seat and backrest; fixing axes are provided on the side of both ends of the said armrests to match the snap spring holes, and grooves for positioning are provided on the fixing axes to match the snap springs in the snap spring holes.

5. A tattoo chair of claim 1, wherein a headrest is removably mounted on the top of the said backrest; a fixing axis with grooves is provided at the bottom of the said headrest; a snap spring hole is provided on the upper surface of the said backrest to match the fixing axis.

6. A tattoo chair of claim 5, wherein an arc hole is provided in the center of the said headrest.

7. A tattoo chair of claim 6, wherein a cushion is provided on the said the surface of the said headrest, and the said cushion is removably connected with the headrest.

8. A tattoo chair of claim 1, wherein a leg rest is provided in the front of the said seat, and the said leg rest is rotatablely attached to the seat; leg rest supporting rods are provided on the rear surface of the said leg rest, and a leg rest fixing brace is provided on the supporting fixed plate under the said seat; the leg rest supporting rods are movably connected with the leg rest fixing brace.

9. A tattoo chair of claim 8, wherein the said leg rest is a symmetrically separate structure comprising a left part and a right part each having a leg rest supporting rod; the left and right leg rest fixing braces is provided on the said supporting fixed plate to match the left and the right leg rest supporting rods.

10. A tattoo chair of claim 9, wherein a position-matched leg rest extension is provided on the lower end of the said leg rest, where the snap spring holes are provided; fixing axes with grooves are provided on the side of the said leg rest extension connected to the leg rest; the fixing axes are removably inserted into the snap spring holes in the lower end of the leg rest, to removably connect the leg rest extension to the leg rest.

11. A tattoo chair of claim 2, wherein armrests are provided on the left, right, or both sides of the said seat and backrest; snap spring holes are provided in the said seat and backrest; fixing axes are provided on the side of both ends of the said armrests to match the snap spring holes, and grooves for positioning are provided on the fixing axes to match the snap springs in the snap spring holes.

12. A tattoo chair of claim 2, wherein a headrest is adjustably mounted on the top of the said backrest.

13. A tattoo chair of claim 2, wherein a leg rest is rotatablely attached to the seat; the said leg rest is a symmetrically separate structure comprising a left part and a right part and wherein a position-matched leg rest extension is removably disposed on the lower end of the said leg rest.

14-20. (canceled)

21. A tattoo chair of claim 1 wherein the backrest includes a narrowed section adjacent the seat to enable a person supported by the tattoo chair to straddle the tattoo chair and face toward the backrest.

22. A tattoo chair of claim 7 wherein the backrest includes an upper portion and a lower portion adjacent the seat, the lower portion has a reduced lateral width relative to the upper portion for facilitating straddling the tattoo chair and facing toward the backrest.

23. An adjustable tattoo chair, comprising:
a seat base supported in an elevated position;
a seat back extending from the seat base and pivotally movable relative to the seat base between an upright position and a generally horizontal position; and
at least one of the seat base and the seat back includes a narrowed portion adjacent the other of said at least one of the seat base and the seat back for facilitating straddling of the tattoo chair.

24. The adjustable tattoo chair of claim 23 wherein the seat back includes the narrowed portion.

25. The adjustable tattoo chair of claim 24 wherein the seat back includes raised bolster portions disposed along lateral sides of the seat back.

26. The adjustable tattoo chair of claim 23 wherein the seat base includes the narrowed portion.

27. The adjustable tattoo chair of claim 23 further including a headrest removably connected to the seat back, the headrest including a main body having a face recess defined therein and a pillow cover removeably secured to the main body for selectively covering the face recess.

28. The adjustable tattoo chair of claim 23 further including a rack gear mounted orthogonally relative to an intersection axis between the seat base and the seat back, and a pivotally mounted member having a free end configured to engage the rack gear for securing the seat back at a desired angle of inclination relative to the seat base.

29. A tattoo chair, comprising:
a seat base;
a seat back extending from the seat base and pivotally movable relative to the seat base between an upright position and a generally horizontal position; and
a headrest removeably secured to an upper end of the seat back, the head rest including a main body portion having a recess disposed in a front side thereof and a plush cover member removeably disposed over the recess, the seat back having an upper side configured to have an occupant's arms rest thereon when straddling the seat base and facing the seat back with the headrest removed from the seat back.

30. The tattoo chair of claim 29 further including:
a pair of leg rests extending from the seat base at an end distal relative to the seat back; and
a pair of leg rest extensions each respectively extending from the pair of leg rests at an end distal relative to the seat base, the pair of leg rest extensions removeably attached to the pair of leg rests to enable to the leg rests to fold down to an angle approximately normal relative to the seat base to facilitate access to an occupant when in a straddle position on the seat base.
